(19) United States
(12) Patent Application Publication
(10) Pub. No.: US 2013/0173334 A1
(43) Pub. Date: Jul. 4, 2013

(54) INFERRING USER DEMOGRAPHICS THROUGH NETWORK ACTIVITY RECORDS

(71) Applicant: UNILOC LUXEMBOURG S.A., Luxembourg (LU)

(72) Inventor: Craig S. ETCHEGOYEN, Newport Beach, CA (US)

(73) Assignee: UNILOC LUXEMBOURG S.A., Luxembourg (LU)

(21) Appl. No.: 13/707,840

(22) Filed: Dec. 7, 2012

Related U.S. Application Data
(60) Provisional application No. 61/568,098, filed on Dec. 7, 2011.

(51) Int. Cl. G06Q 30/02

(52) U.S. Cl. CPC G06Q 30/0201
USPC 705/7.29

(57) ABSTRACT

Personal information on a networked client computer is used by a server from which the device has requested information to infer demographic characteristics of the user of the client computer in order to add customized content to the requested information. The personal information provided to the server is gathered from the use of network browser software by the client computer and includes cookies, history and bookmarks. Inferring demographic characteristics of the user involves application of predetermined demographics inference rules stored by the server to the personal information provided by the client.

This application claims priority pursuant to 35 U.S.C. §119(e) to U.S. provisional application Ser. No. 61/568,101, filed Dec. 7, 2012, which application is specifically incorporated herein, in its entirety, by reference.

### BACKGROUND OF THE INVENTION

1. Field of the Invention

The present invention relates generally to computer network services and, more particularly, methods of and systems for identifying the user of a network client computing device by data stored thereon.

2. Description of the Related Art

One of the more important benefits of the current Internet-based world in which we live is mass customization. Exploitation of the mass customization afforded by intelligent interaction with customers through the Internet has led to a large number of successful “long tail” business models. Thus, the ability to customize the experience of each user of Internet-based services is now well-recognized as very important and very valuable.

Of course, such customization requires possession of information about the user before the experience can be customized for that user. Accordingly, the user's experience is rather generic until the user has taken the additional step of identifying herself and/or entering data representing some of her characteristics. Of course, requiring entry by the user of data specifying characteristics of the user is a nuisance. In addition, many users perceive personal questions from web sites to be a bit creepy and to present significant privacy concerns.

The ability to quickly and automatically infer some demographic characteristics of unknown users would significantly enhance such users' experience and would represent a significant advancement in the art.

### SUMMARY OF THE INVENTION

In accordance with the present invention, demographic characteristics, and therefore interests and some broad personality characteristics, of a user of a networked computer are inferred by a remotely-located server from data representing network activity of the user. Personal information relating to network activity by the user's computer is accumulated from the use of one or more browsers used on the networked client computer and sent to a server. The server uses the network activity data to infer a demographic profile of the user. This demographic profile allows the server to add customized network content to pages sent at the request of the client computer as well as to anticipate changes in the interests of the user of the client networked computer.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a client computer and a server computer that cooperate to perform user demographic inference in accordance with one embodiment of the present invention.

FIG. 2 is a transaction flow diagram illustrating the manner in which the client device and server computer of FIG. 1 cooperate to perform user demographic inference so as to be able to send customized content based on inferred user demographic.

FIG. 3 is a logic flow diagram illustrating the manner in which the client device creates a usage profile in a step of the transaction flow diagram of FIG. 2 in greater detail.

FIG. 4 is a logic flow diagram illustrating the manner in which the server computer infers the user's demographic in a step of the transaction flow diagram of FIG. 2 in greater detail.

FIG. 5 is a block diagram showing in greater detail the server computer of FIG. 1, including demographic reference data.

FIG. 6 is a block diagram showing in greater detail the client computer of FIG. 1, including browser personal information.

FIG. 7 is a block diagram of a usage profile data record used by the server computer to represent the user of a client computer.

FIG. 8 is a block diagram of a demographic inference record used by the server computer that controls the manner in which the server computer infers demographic characteristics of a user from the usage profile.

### DETAILED DESCRIPTION

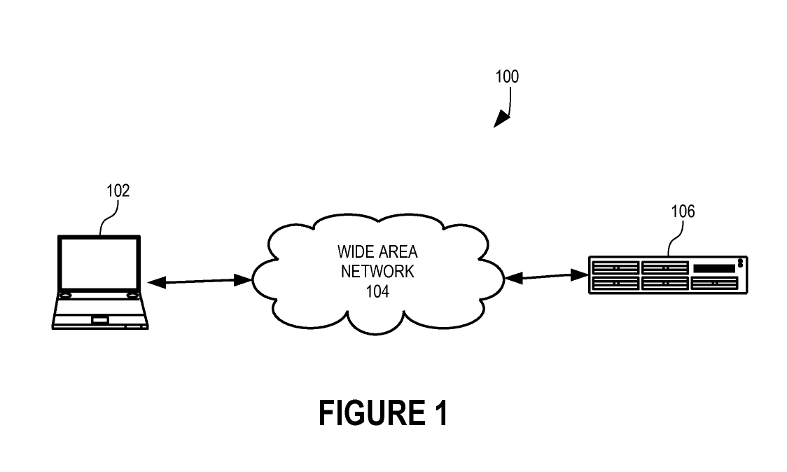

In accordance with the present invention, a server 106 (FIG. 1) can infer demographic characteristics of a user of a remotely-located client computer 102 without requiring the user to identify herself or provide any demographic information whatsoever. Records of the user's network activity in client computer 102 (FIG. 1) to date are received by server 106 and used to create a demographic profile of the user.

Client computer 102 can be any of a number of types of networked client computing devices, including smartphones, tablets, netbooks, laptops, and desktops. When client computer 102 sends a request to server 106, personal information stored by client computer 102 is compared to one or more demographic profiles resident on server 106 so that content added by server 106 to the requested page can be customized. Sources of the personal information on the client computer 102 can include cookies, browsing history, and bookmarks and can therefore include information drawn from a broad range of network browser activity including the user's consumer preferences, politics, economic and/or social class, intellectual interests, job, sports participation and team tracking, stock-watching, travel habits—including hotel, car rental, and airline sites—ethnicity, race, religion, celebrities and bloggers followed, movies, computers, phones and software used, hobbies, geographic location, national identity, use of social networking sites such as Twitter and Facebook, marital status, children, and educational background.

Demographic inference information stored on server 106 are based on one or more widely shared characteristics of individuals, including age, ethnicity, income, gender and geography, for example. But, it should be understood that many other types of characteristics can be used to create more or different demographic profiles.

In a manner described more completely below, server 106 processes the personal information gathered by client computer 102 and infers demographic characteristics of the user, enabling server 106 to send unrequested information likely to be of interest to the user of client computer 102 whether the user has previously shown interest in such information or not. In other words, the demographic characteristics of a user not only makes it possible for server 106 to infer the past activities and preferences of the user but also can be likely to be able to predict what the user of the client will want to do in the future—including interest in new products and new ideas, as well as the loss of interest in other products and ideas. This predictive capability is accomplished through the tracking of, for example, a product's life cycle among identified early adopters within the user's demographic group. A change in product preference among early adopters can presage a gradual change in product preference for the entire demographic.

As shown in FIG. 1, client computer 102 and server 106 communicate with one another through a wide area network 104, which is the Internet in this illustrative example.

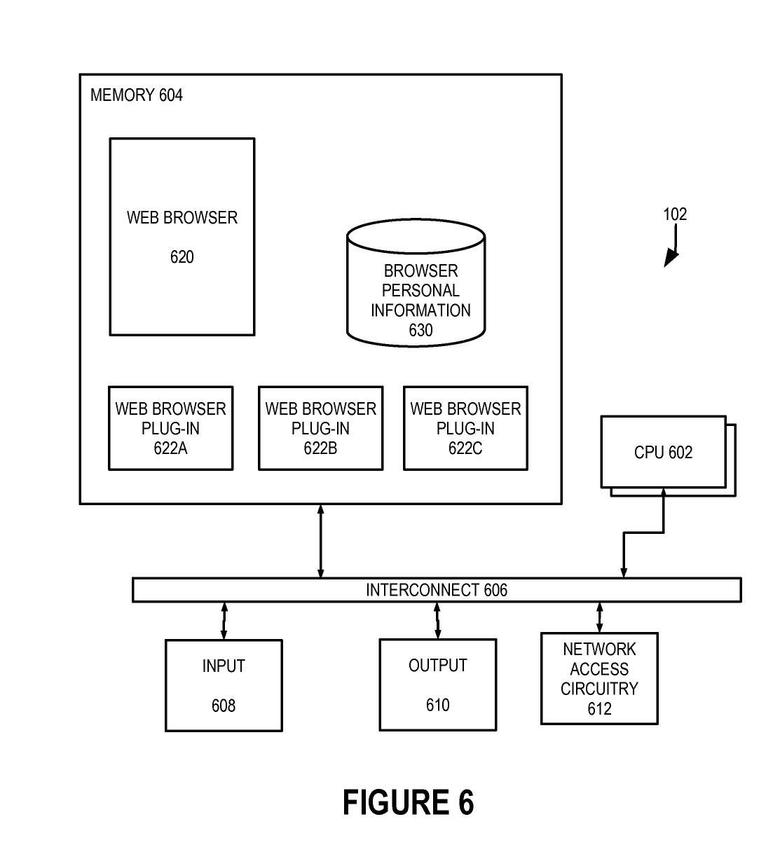

Server 106 (FIG. 1) infers demographic characteristics of client computer 102 in this illustrative example from the client's browser personal information 630 (FIG. 6) stored on client computer 102 (FIG. 1). Browser personal information 630 is a large and growing record maintained in client device 102 and includes information from cookies, browser history, and bookmarks.

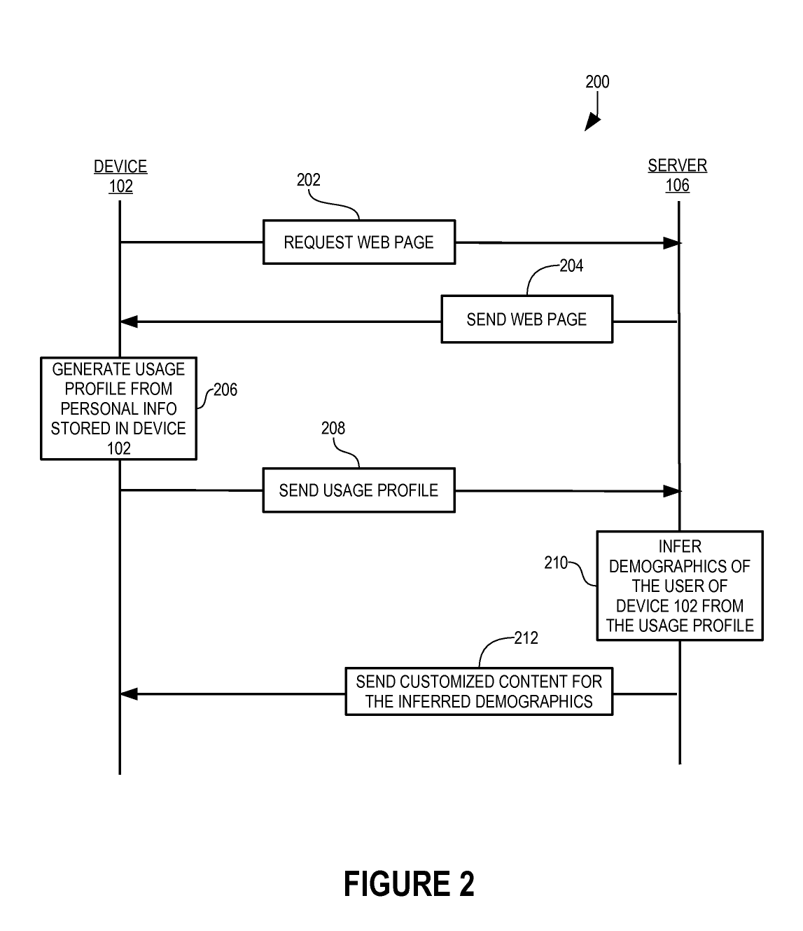

Transaction flow diagram 200 (FIG. 2) represents the manner in which client computer 102 and server 106 cooperate to infer demographic characteristics of the user of client device 102 in accordance with the present invention.

In step 202, client computer 102 sends a request for a web page to server computer 106. The request can be in the form of a URL specified by the user of client computer 102 using a web browser 620 (FIG. 6) executing in client computer 102 and conventional user interface techniques involving physical manipulation of user input devices 608. Web browser 620 and user input devices 708 and other components of client computer 102 are described in greater detail below.

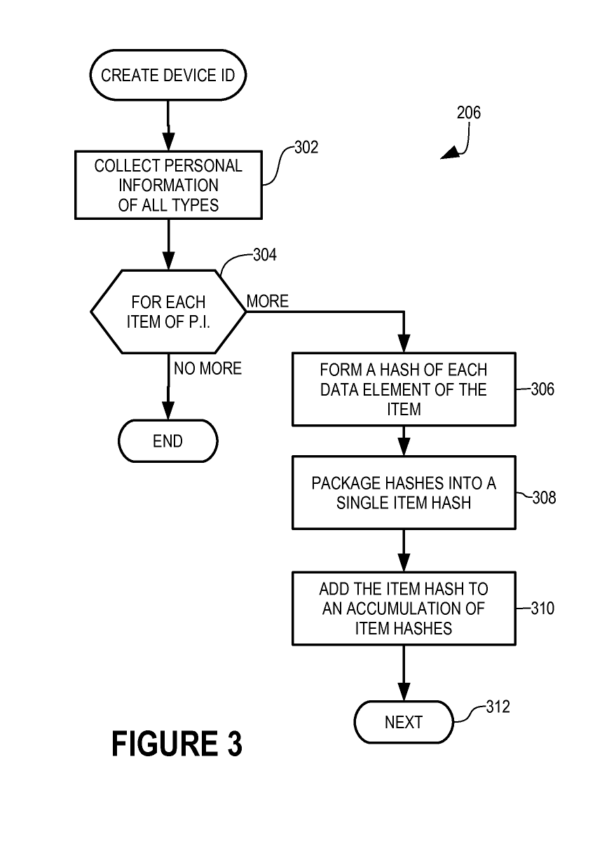

In step 204 (FIG. 2), server 106 sends the web page that is identified by the request received in step 202. The web page sent to client computer 102 includes content that causes web browser 620 of client computer 102 to generate a current usage profile for client computer 102 from browser personal information 630 (FIG. 6). In one embodiment, a web browser plug-in 622C is installed in client device 102 and, invoked by web browser 620, processes the content of the web page to generate the usage profile from browser personal information 630. The various elements of client computer 102 and their interaction are described more completely below. In addition, step 206 is described more completely below with respect to logic flow diagram 206 (FIG. 3).

In step 208, client computer 102 sends the usage profile that was generated in step 206 to server 106.

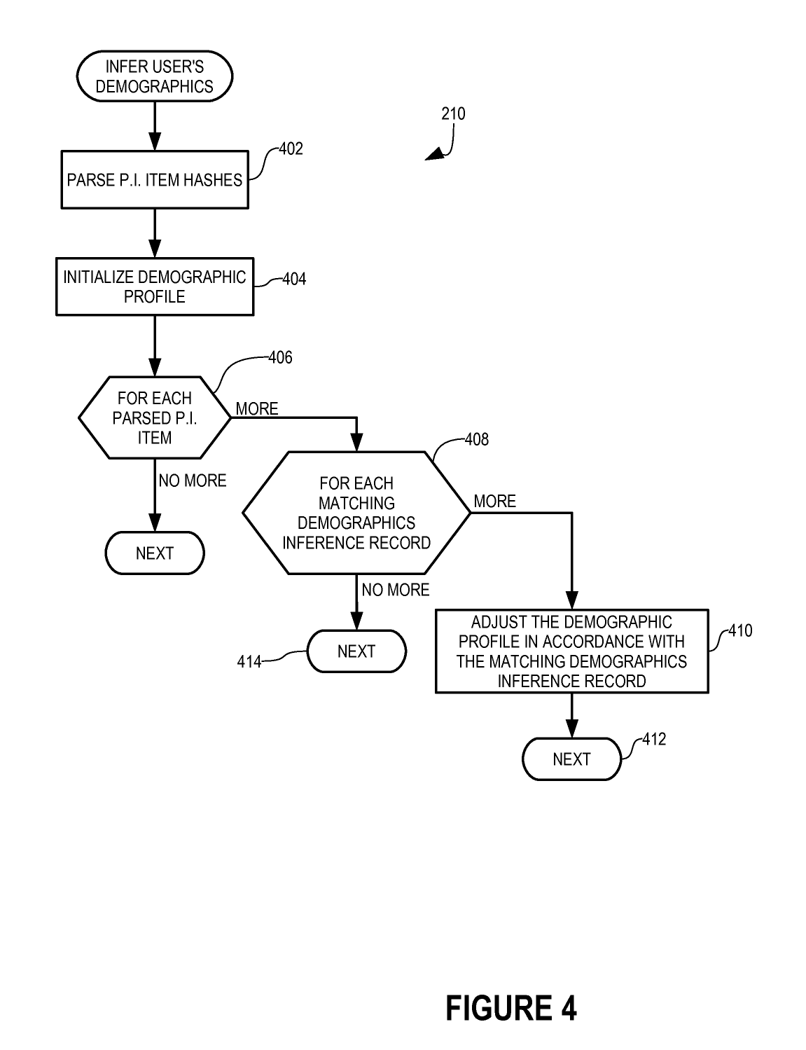

In step 210, server 106 infers one or more demographic characteristics of the user of client device 102 from the usage profile received in step 208. Step 210 is described in greater detail below in conjunction with logic flow diagram 210 (FIG. 4).

In step 212, server 106 sends content customized according to the one or more inferred demographic characteristics to client computer 102.

As described above, client computer 102 generates a usage profile from browser personal information 630 (FIG. 6) in step 206 (FIG. 2), and step 206 is shown in greater detail as logic flow diagram 206 (FIG. 3). In this illustrative embodiment, step 206 is performed by web browser plug-in 622C (FIG. 6).

In step 302 (FIG. 3), web browser plug-in 622C collects personal information of all types from browser personal information 630, which includes a number of items of personal information having a type and a value. Item types can include generally any type of personal information stored and used by web browser 620 (FIG. 6), including cookies, bookmarks, saved form data, browsing history items, sites for which passwords are stored (though preferably not the passwords themselves for privacy reasons), plug-ins, and fonts. Such items represent user-initiated network activity of client computer 102 and can be indicative of subjective preferences of the user.

Loop step 304 and next step 312 define a loop in which web browser plug-in 622C processes each item of personal information in accordance with steps 304-314. The particular item of 630 processed by web browser plug-in 762C during each iteration of the loop of steps 304-314, is sometimes referred to herein as “the subject item.”

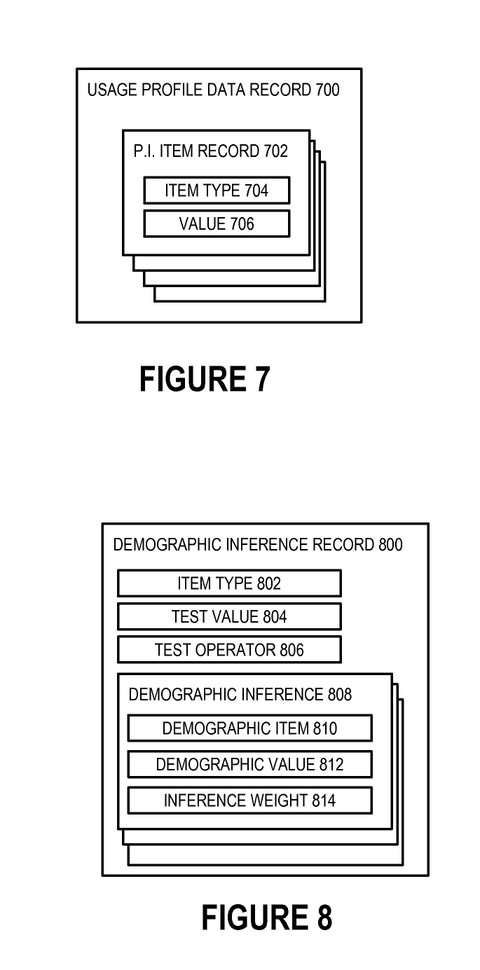

In step 306, web browser plug-in 622C forms a reversible hash of each data element of the subject item. Each data element of the subject item is hashed by web browser plug-in 622C to hide personal during transport through wide area network 104 (FIG. 1). In particular, item type 704 (FIG. 7) of personal information item record 702 is a hash of the type of the subject item, and value 706 is a has of the value of the subject item.

In step 308, web browser plug-in 622C packages all the reversible hashes of data elements of the subject item into a single, reversible hash representing the subject item in its entirety. Web browser plug-in 622C forms personal information item record 702 as a hash of item type 704 and value 706 in this illustrative embodiment.

In step 310, web browser plug-in 622C adds the hash created in step 308 to an accumulation of data item hashes. The accumulation of data item hashes is a usage profile sent to server 106 in step 208.

Once all of data items 630 (FIG. 6) have been processed by web browser plug-in 622C according to the loop of steps 304-312 (FIG. 3), processing according to logic flow diagram 206, and therefore step 206 (FIG. 2), completes. The resulting usage profile is an accumulation of hashes that represent multiple items of personal information stored on client device 102 that represent user-initiated network activity and therefore subjective preferences of the user.

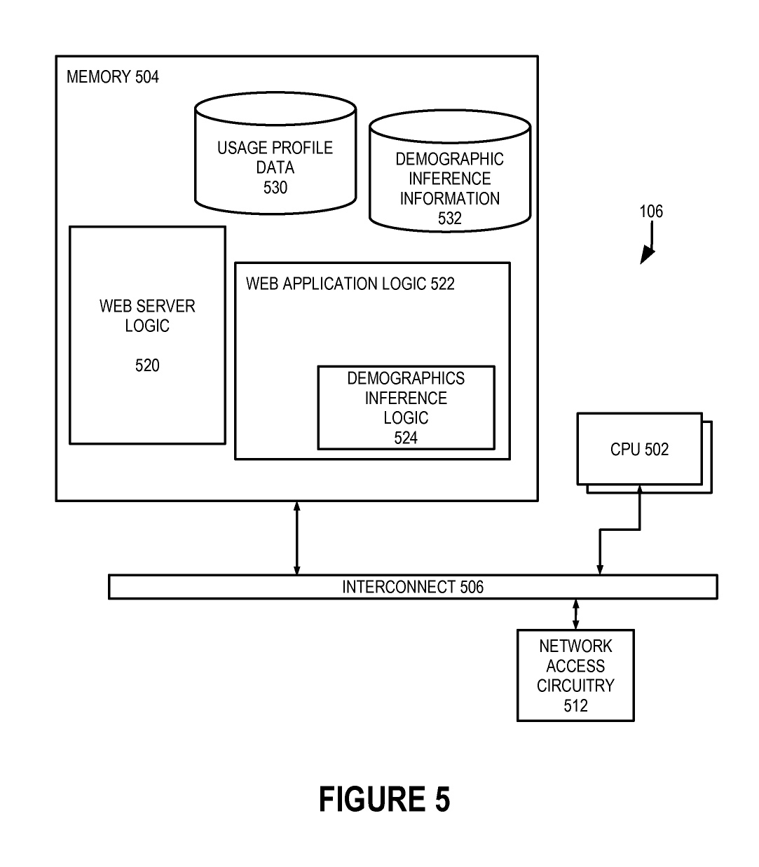

As described above, server 106 (FIG. 1) infers one or more demographic characteristics of the user in step 210 from the usage profile received in step 208 (FIG. 2). This is shown in greater detail as logic flow diagram 210 (FIG. 4). The usage profile is stored by server 106 as a usage profile data record 700 (FIG. 7) in usage profile data 530 (FIG. 5).

In step 402 (FIG. 4), demographic inference logic 524 parses individual reversible hashes representing whole, individual items of personal information from the device identifier data 530 and parses the reversible hashes of individual data items from each of the parsed reversible hashes.

In step 404, demographic inference logic 524 initializes a demographics profile. In particular, demographic inference logic 524 represents all demographic characteristics of the user associated with device identifier data record 700 are initialized to be unknown.

Loop step 406 and next step 414 define a loop in which demographic inference logic 524 processes each personal information item record 702 of usage profile data record 700 according to steps 408-412. During each iteration of the loop of steps 406-414, the particular personal information item processed by demographic inference logic 524 is sometimes referred to as “the subject personal information item” in the context of logic flow diagram 210. In the same context, personal information record 702 represents the subject personal information item. In particular, item type 704 and value 706 represent the type and value, respectively, of the subject personal information item.

In loop step 408, demographics inference logic 524 identifies one or more matching demographics inference records, such as demographics inference record 800 (FIG. 8), for the subject personal information item. Demographics inference record 800 matches the personal information item represented by personal information item record 702 if item type 802 and item type 704 are the same and application of test value 804 to value 706 with test operator 806 yields a “true” result.

It may be helpful to consider the following example. Suppose item type 802 specifies a browser bookmark, test value 804 specifies a regular expression, and test operator 806 specifies a regular expression match operation. Demographic inference record 800 would them match personal information item record 702 if item type 704 indicates a browser bookmark and value 706 is matched by the regular expression of test value 804.

For each matching demographics inference record for the subject personal information item, processing by demographics inference logic 524 transfers from loop step 408 to step 410.

In step 410, demographics inference logic 524 adjusts the demographic profile according to demographics inference 808 (FIG. 8) of the matching demographics inference record. Demographic item 810 represents a demographic characteristic to be adjusted. Examples include gender, age, annual income, geographic region, and specific interests. For example, if demographic item 810 represents gender, demographic value 812 represents “male” or “female.” Demographic value 812 represents a particular value for demographics item 810. Inference weight 814 represents an amount by which the user's demographic characteristic represented by demographic item 810 is biased toward the value represented by demographic value 812.

In an example, if demographic item 810 represents gender, and demographic value 812 represents male, inference weight 814 is added to an accumulating male gender counter. A comparison of the male gender counter to a female gender counter ultimately decides the likely gender of the user. In addition, a predetermined minimum difference between the male and female gender counters can be required to comfortably infer one gender or the other.

There may, of course, be many different items of personal information that suggest gender, including clothing interests, sports, cars, and entertainment, each of which is considered to suggest a male or female user. Some items will have far more weight as a gender identifier than others. As an example, a magazine preference—indicated by a browser bookmark, a link in a browser history, or a saved password—for Field & Stream might suggest a male user, and a preference for Ms. might suggest a female user since the readers of each are historically strongly polarized by gender. A compilation of several such similarly strongly indicative items makes it possible for the server to infer one or more personal characteristics of the user. Such characteristics can include income, food and drink preferences, travel destinations, job, leisure time activities, and when well-chosen can be as valuable to demographic inferences as magazine choices can be for gender.

Inferences, such as represented in demographics inference record 800 for example, can be determined empirically by statistical analysis of system information of a number of known users. For example, computer users sometimes voluntarily share detailed demographic information about themselves. Examples include customer surveys for marketing or scientific research and profiles for on-line social networking. When a user voluntarily provides information about her own demographic characteristics, personal information such as personal information 630 (FIG. 6) is gathered and associated with the demographic information such that statistical regression can be performed to determine proper demographic inferences from such system information.

When the loop process 406-414 is complete because there are no more personal information items to compare to demographics inference records and therefore no further adjustments to be made to the demographic profile of the client, processing by demographics inference logic 524 according to logic flow diagram 210, and therefore step 210 (FIG. 2), completes. The inferred demographic profile of the user is the result of cumulative adjustments made to the demographics profile initialized as neutral in step 404. To the extent the inferred demographics profile of the user suggests one or more demographic characteristics of the user to be inferred with a predetermined degree of certainty, web application logic 522 can select content specifically tailored to users of those demographics characteristics.

The network behavior of the great majority of users of computer devices is sufficiently similar as to make it possible to limit the number of different predetermined demographics profiles while still accurately anticipating the interests of the users of client devices. Since some clients are early adopters of new products and ideas, other clients with the same demographic profile can be predicted to eventually make the same changes. Tracking persisting new variations in personal identification data from a demographic profile provides a clue to the future behavior of others with the same profile. Information on known early adopters is manually entered into the demographic profile data resident on server 106. In one embodiment, early adopters are identified by persistent, new items that do not find a match at step 408 in demographics inference records 800.

Server computer 106 is shown in greater detail in FIG. 5. Server 106 includes one or more microprocessors 502 (collectively referred to as CPU 502) that retrieve data and/or instructions from memory 604 and execute retrieved instructions in a conventional manner. Memory 504 can include generally any computer-readable medium including, for example, persistent memory such as magnetic and/or optical disks, ROM, and PROM and volatile memory such as RAM.

CPU 502 and memory 504 are connected to one another through a conventional interconnect 506, which is a bus in this illustrative embodiment and which connects CPU 502 and memory 504 to network access circuitry 512. Network access circuitry 512 sends and receives data through computer networks such as wide area network 104 (FIG. 1).

A number of components of server 106 are stored in memory 504. In particular, web server logic 520 and web application logic 522, including demographics inference logic 524, are all or part of one or more computer processes executing within CPU 502 from memory 504 in this illustrative embodiment but can also be implemented using digital logic circuitry.

Web server logic 520 is a conventional web server. Web application logic 522 is content that defines one or more pages of a web site and is served by web server logic 520 to client devices such as client device 102. Demographics inference logic 524 is a part of web application logic 522 that infers one or more demographic characteristics of users of client devices in the manner described above.

Client device 102 is a personal computing device and is shown in greater detail in FIG. 6. Client device 102 includes one or more microprocessors 602 (collectively referred to as CPU 602) that retrieve data and/or instructions from memory 604 and execute retrieved instructions in a conventional manner. Memory 604 can include generally any computer-readable medium including, for example, persistent memory such as magnetic and/or optical disks, ROM, and PROM and volatile memory such as RAM.

CPU 602 and memory 604 are connected to one another through a conventional interconnect 606, which is a bus in this illustrative embodiment and which connects CPU 602 and memory 604 to one or more input devices 608, output devices 610, and network access circuitry 612. Input devices 608 can include, for example, a keyboard, a keypad, a touch-sensitive screen, a mouse, a microphone, and one or more cameras. Output devices 610 can include, for example, a display—such as a liquid crystal display (LCD)—and one or more loudspeakers. Network access circuitry 612 sends and receives data through computer networks such as wide area network 104 (FIG. 1).

A number of components of client device 102 are stored in memory 604. In particular, web browser 620 is all or part of one or more computer processes executing within CPU 602 from memory 604 in this illustrative embodiment but can also be implemented using digital logic circuitry. As used herein, “logic” refers to (i) logic implemented as computer instructions and/or data within one or more computer processes and/or (ii) logic implemented in electronic circuitry. Web browser plug-ins 622A-C are each all or part of one or more computer processes that cooperate with web browser 620 to augment the behavior of web browser 620. The manner in which behavior of a web browser is augmented by web browser plug-ins is conventional and known and is not described herein.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for characterizing a user of a remotely-located computer, the method comprising:
receiving personal information from the remotely-located computer, wherein the personal information includes one or more items of data representing prior user-initiated network activity of the remotely-located computer;
for each of the items of data of the personal information:
determining that one or more predetermined demographic characteristic inference rules apply to the item of data; and
adjusting one or more demographic characteristic inferences according to the applicable predetermined demographic characteristic inference rules; and
inferring one or more characteristics of the user from the demographic characteristic inferences.

2. The method of claim 1 wherein the personal information is gathered from a browser that executes in the remotely-located computer.

3. The method of claim 1 wherein the personal information is hashed.

4. The method of claim 1 further comprising sending customized content to the remotely-located computer wherein the customized content is determined based on the inferred characteristics of the user.

5. The method of claim 1 wherein the inference rules each include a demographic value and inference weight;
wherein adjusting of a selected one of the demographic characteristic inferences according to a selected one of the inference rules comprises adjusting the selected demographic characteristic inference toward the demographic value of the selected inference rule to a degree specified by the inference weight of the selected inference rule; and
wherein the demographic value and inference weight are predetermined based on empirical evidence.

6. A computer readable medium useful in association with a computer that includes one or more processors and a memory, the computer readable medium including computer instructions that are configured to cause the computer, by execution of the computer instructions in the one or more processors from the memory, to characterize a user of a remotely-located computer by at least:
receiving personal information from the remotely-located computer, wherein the personal information includes one or more items of data representing prior user-initiated network activity of the remotely-located computer;
for each of the items of data of the personal information data:
determining that one or more predetermined demographic characteristic inference rules apply to the item of data; and
adjusting one or more demographic characteristic inferences according to the applicable predetermined demographic characteristic inference rules; and
inferring one or more characteristics of the user from the demographic characteristic inferences.

7. The computer readable medium of claim 6 wherein the personal information is gathered from a browser that executes in the remotely-located computer.

8. The computer readable medium of claim 6 wherein the personal information is hashed.

9. The computer readable medium of claim 6 wherein execution of the computer instructions further comprises sending customized content to the remotely-located computer wherein the customized content is determined based on the inferred characteristics of the user.

10. The computer readable medium of claim 6 wherein the inference rules each include a demographic value and inference weight;
wherein adjusting of a selected one of the demographic characteristic inferences according to a selected one of the inference rules comprises adjusting the selected demographic characteristic inference toward the demographic value of the selected inference rule to a degree specified by the inference weight of the selected inference rule; and
wherein the demographic value and inference weight are predetermined based on empirical evidence.

11. A computer system comprising:
at least one processor;
a computer readable medium that is operatively coupled to the processor;
network access circuitry that is operatively coupled to the processor; and
demographic inference logic (i) that executes at least in part in the processor from the computer readable medium and (ii) that, when executed, causes the processor to infer one or more demographic characteristics of a user of a remotely-located computer by at least:
receiving personal information from the remotely-located computer, wherein the personal information includes one or more items of data representing prior user-initiated network activity of the remotely-located computer;
for each of the items of data of the personal information:
determining that one or more predetermined demographic characteristic inference rules apply to the item of data; and
adjusting one or more demographic characteristic inferences according to the applicable predetermined demographic characteristic inference rules; and
inferring one or more characteristics of the user from the demographic characteristic inferences.

12. The computer system of claim 11 wherein the personal information is gathered from a browser that executes in the remotely-located computer.

13. The computer system of claim 11 wherein the personal information is hashed.

14. The computer system of claim 11 wherein execution of the demographic inference logic further causes the processor to send customized content to the remotely-located computer wherein the customized content is determined based on the inferred characteristics of the user.

15. The computer system of claim 11 wherein the inference rules each include a demographic value and inference weight;
wherein adjusting of a selected one of the demographic characteristic inferences according to a selected one of the inference rules comprises adjusting the selected demographic characteristic inference toward the demographic value of the selected inference rule to a degree specified by the inference weight of the selected inference rule; and
wherein the demographic value and inference weight are predetermined based on empirical evidence.
